(19) United States
(12) Patent Application Publication
(10) Pub. No.: US 2026/0187962 A1
(43) Pub. Date: Jul. 2, 2026

(54) IMAGE PROCESSING METHOD, COMPUTER DEVICE, AND COMPUTER-READABLE STORAGE MEDIUM

(71) Applicant: WUHAN UNITED IMAGING HEALTHCARE CO., LTD., Wuhan (CN)

(72) Inventors: Junyang Zhang, Wuhan (CN); Fei Zhu, Wuhan (CN); Haiwei Song, Wuhan (CN)

(21) Appl. No.: 19/437,404

(22) Filed: Dec. 31, 2025

(30) Foreign Application Priority Data
Dec. 31, 2024 (CN) 202411997449.X

(51) Int. Cl. G06V 10/25; G06V 10/26; G06V 10/77; G06V 10/776; G06V 10/82

(52) U.S. Cl. CPC G06V 10/25; G06V 10/26; G06V 10/7715; G06V 10/776; G06V 10/82; G06V 2201/031

(57) ABSTRACT

The present disclosure relates to an image processing method, a computer device, and a non-transitory computer-readable storage medium. The image processing method includes obtaining a medical image to be processed; inputting the medical image into a trained detection model to obtain at least one mask image of at least one target region in the medical image, and to obtain at least one key point corresponding to the at least one target region.

### CROSS-REFERENCE TO RELATED APPLICATIONS

This application claims priority to Chinese Patent Application No. 202411997449.X, filed on Dec. 31, 2024, entitled “IMAGE PROCESSING METHOD, APPARATUS, COMPUTER DEVICE, AND COMPUTER READABLE STORAGE MEDIUM”, the content of which is hereby incorporated by reference in its entirety.

### TECHNICAL FIELD

The present disclosure relates to the technical field of medical image processing, and in particular, to an image processing method, a computer device, and a non-transitory computer-readable storage medium.

### BACKGROUND

As a safe, non-invasive, low-cost, and real-time medical imaging technology, ultrasonic imaging has been widely used in clinical practice. However, the high image noise and unclear boundaries of the ultrasonic imaging are likely to lead to missed diagnosis and misdiagnosis. As two basic tasks in computer vision, image segmentation and key point detection can locate the region of interest and related positions in ultrasonic images accurately in real time, thereby assisting clinicians in completing qualitative and quantitative analysis of ultrasonic images, and improving work efficiency and diagnosis accuracy.

### SUMMARY

In a first aspect, an image processing method is provided. The image processing method includes:
obtaining a medical image to be processed; and
inputting the medical image into a trained detection model to obtain at least one mask image of at least one target region in the medical image, and to obtain at least one key point corresponding to the at least one target region.

In a second aspect, an image processing apparatus is further provided. The image processing apparatus includes:
an obtaining module, configured to obtain a medical image to be processed; and
a detection module, configured to input the medical image into a trained detection model to obtain at least one mask image of at least one target region in the medical image and at least one heatmap of at least one key point corresponding to the at least one target region.

In a third aspect, a computer device is further provided. The computer device includes a memory and a processor. The memory stores a computer program. The processor, when executing the computer program, implements the following steps:
obtaining a medical image to be processed; and
inputting the medical image into a trained detection model to obtain at least one mask image of at least one target region in the medical image, and to obtain at least one key point corresponding to the at least one target region.

In a fourth aspect, a non-transitory computer-readable storage medium is further provided, on which at least one computer program is stored. The computer program, when executed by at least one processor, implements the following steps:
obtaining a medical image to be processed; and
inputting the medical image into a trained detection model to obtain at least one mask image of at least one target region in the medical image, and to obtain at least one key point corresponding to the at least one target region.

In a fifth aspect, a computer program product is further provided. The computer program product includes a computer program. The computer program, when executed by a processor, implements the following steps:
obtaining a medical image to be processed; and
inputting the medical image into a trained detection model to obtain at least one mask image of at least one target region in the medical image, and to obtain at least one key point corresponding to the at least one target region.

In a sixth aspect, a model training method is further provided. The model training method includes:
predicting at least one sample image based on a detection model to be trained to obtain at least one predicted mask image of the sample image and at least one predicted feature map of at least one key point;
determining a first loss according to the at least one predicted mask image, and determining a second loss according to the at least one predicted mask image and the at least one predicted feature map based on the detection model to be trained; and
training the detection model to be trained according to the first loss and the second loss to obtain the trained detection model.

In a seventh aspect, an image processing system is further provided. The image processing system includes:
encoding layers of multiple levels, configured to perform feature encoding on a medical image;
decoding layers of multiple levels, configured to perform feature decoding on the medical image;
an attention block, configured to obtain at least one mask image of at least one target region in the medical image, and to obtain at least one key point corresponding to the at least one target region.

### BRIEF DESCRIPTION OF DRAWINGS

To describe the technical solutions in the embodiments of the present disclosure or in the related art clearly, the following briefly introduces the accompanying drawings required for describing the embodiments of the present disclosure or the related art. Obviously, the accompanying drawings described below only involve some embodiments of the present disclosure, and those of ordinary skill in the art can obtain other accompanying drawings according to these accompanying drawings without inventive efforts.

FIG. 1 is a schematic flowchart of an image processing method in an embodiment.

FIG. 2 is a schematic diagram of a structure of a multi-task detection model for segmentation and key points in an embodiment.

FIG. 3 is a schematic diagram of a standard section of a parasternal pulmonary artery of an ultrasonic image along a long axis in an embodiment.

FIG. 4 is a schematic diagram of a network structure for a section of a parasternal pulmonary artery along a long axis in an embodiment.

FIG. 5 is a schematic diagram of a result of a section of a parasternal pulmonary artery along a long axis predicted by a model in an embodiment.

FIG. 6 is a schematic flowchart of an image processing method in another embodiment.

FIG. 7 is a structural block diagram of an image processing apparatus in an embodiment.

FIG. 8 is an internal structural diagram of a computer device in an embodiment.

### DETAILED DESCRIPTION

To make the objectives, technical solutions, and advantages of the present disclosure clearer, the present disclosure is further described in detail below with reference to the accompanying drawings and embodiments. It should be understood that the specific embodiments described herein are only used to explain the technical solutions of the present disclosure, and are not intended to limit the technical solutions of the present disclosure.

It should be noted that the terms “first”, “second”, and the like in the specification and claims of the present disclosure and the above accompanying drawings are used to distinguish similar objects, and are not necessarily used to describe a specific sequence or order. It should be understood that the data determined by these terms can be interchanged where appropriate, so that the embodiments of the present disclosure described herein can be implemented in an order other than those illustrated or described herein.

In the present disclosure, a feature modified by the indefinite article “a”, “an”, “the”, or a singular determiner shall be construed as referring to at least one feature, at least one of a plurality of features, or a plurality of features. For example, “a key point” shall be construed as referring to at least one key point, at least one of a plurality of key points, or a plurality of key points.

In related art, image segmentation and key point detection are usually trained as two independent tasks and then used in combination. This not only fails to achieve end-to-end processing, but also breaks the association between segmentated regions and key points, making it impossible to be compatible with the two tasks of image segmentation and key point detection. In practical applications, different detectors are also used to train the two tasks of image segmentation and key point detection at the same time, but this increases the complexity of network models and raises the cost of training and inference.

Therefore, the current medical image processing has a problem in that no network model can be compatible with the two tasks of segmentation and key point detection. Accordingly, it is necessary to provide an image processing method, a computer device, a non-transitory computer-readable storage medium, and a computer program product that can be compatible with the two tasks of segmentation and key point detection to address the above technical problem.

In an embodiment, as shown in FIG. 1, an image processing method is provided. This embodiment takes the application of the image processing method to a terminal as an example for description. It can be understood that the image processing method can also be applied to a server, or to a system including a terminal and a server, and implemented through interaction between the terminal and the server. In this embodiment, the image processing method includes the following Step S102 to Step S104.

In Step S102, a medical image to be processed is obtained.

In an embodiment, the medical image includes, but is not limited to, an ultrasonic image, a magnetic resonance image, a Positron Emission Tomography/Computed Tomography (PET/CT) image, a Single-Photon Emission Computed Tomography (SPECT) image, or an X-ray image, and the like.

In a specific implementation, the medical image to be subjected to image segmentation and key point detection can be used as the medical image to be processed and input to the terminal.

In Step S104, the medical image is input into a trained detection model to obtain at least one mask image of at least one target region in the medical image, and to obtain at least one key point corresponding to the at least one target region.

In an embodiment, the detection model can be a model capable of performing image segmentation and key point detection at the same time, and can be composed of different network structures and attention mechanisms. The target region can be a concerned anatomical structure. The mask image can be an image segmentation result of the at least one target region. The key point can be a point of a specific part in the target region of the anatomical structure in the mask image. For example, the key point may be a point belonging to a pulmonary valve in the mask image.

In an embodiment, at least one target region can correspond to a mask image. A mask image can include at least one key point. The key point is conducive to image segmentation of the at least one target region. The key point can be determined by a user based on the diagnostic experience thereof.

In an embodiment, the at least one heatmap of the at least one key point corresponding to the at least one target region is a probability distribution map conforming to a Gaussian distribution generated based on the position of the key point.

In an embodiment, the medical image to be processed can include at least one target region to be segmented and at least one key point corresponding to the at least one target region to be extracted. The terminal can pretrain the detection model to obtain a trained detection model. The medical image is input into the trained detection model. The at least one mask image of the at least one target region and the at least one heatmap of the at least one key point are obtained at the same time. The mask image can reflect the image segmentation result. The heatmap can reflect a key point detection result.

In an embodiment, the detection model can include an encoder-decoder structure and an attention mechanism module. After completing model training, the terminal can input the medical image to be processed into the encoder-decoder structure. The mask image of each target region and the feature map of each key point can be output at the same time. The terminal can also obtain an attention coefficient by using the mask image corresponding to the at least one key point in the attention mechanism module, and determine the heatmap corresponding to the at least one key point according to the obtained attention coefficient.

The above image processing method includes obtaining the medical image to be processed, inputting the medical image into the trained detection model to obtain the at least one mask image of the at least one target region in the medical image and the at least one heatmap of the at least one key point corresponding to the at least one target region. Based on the detection model, both the mask image reflecting the image segmentation result and the heatmap reflecting the key point detection result can be obtained at the same time, without the requirement to perform model training separately for image segmentation and key point detection. The image processing method can be well compatible with the two tasks of image segmentation and key point detection.

In an embodiment, the detection model includes an extraction model and an attention model. Step S104 can specifically include:
inputting the medical image into the trained extraction model to obtain the at least one mask image of the at least one target region in the medical image and a feature map of the key point; and
applying an attention mechanism to the at least one feature map according to the at least one mask image based on the trained attention model to obtain the at least one heatmap of at least one the key point.

In an embodiment, the extraction model can include an encoder and a decoder. The encoder and the decoder can complete the encoding and decoding of the medical image to be detected, respectively. The encoder and the decoder can use the same or different deep learning network model structures. The extraction model can extract the at least one mask image of the at least one target region and the at least one feature map of the at least one key point at the same time. The extraction model can be implemented through different deep learning network model structures. The feature map can be an image reflecting a feature of the key point. The attention model can use an attention mechanism on the at least one feature map according to the at least one mask image.

In an embodiment, the terminal can input the medical image to be processed into the trained extraction model. The terminal can obtain the at least one mask image of the at least one target region and the at least one feature map of the at least one key point corresponding to the at least one target region at the same time. The terminal can input the at least one mask image and the at least one feature map into the trained attention model. The terminal can use an attention mechanism on the at least one feature map according to the at least one mask image in the trained attention model. The terminal can obtain the at least one heatmap of the at least one key point.

In an embodiment, the terminal can input the medical image to be processed into the trained deep learning network model. The mask image of each target region and the feature map of each key point can be output at the same time. Since each key point may be located on a different mask image, there is a strong correlation between the key point and the mask image. Therefore, based on prior position information (for example, the key point), one or more attention blocks (for example, Attention Unets) can be used to obtain attention coefficients of the attention blocks (for example, the attention coefficients of Attention Unets) by using the mask image corresponding to the at least one key point. The at least one heatmap of the at least one key point can be obtained by a product of the obtained attention coefficient and the at least one feature map of the at least one key point.

In this embodiment, by inputting the medical image into the trained extraction model, the at least one mask image of the at least one target region in the medical image and the at least one feature map of the at least one key point can be obtained. Based on the trained attention model, by applying the attention mechanism to the at least one feature map according to the at least one mask image, the at least one heatmap of the at least one key point can be obtained. The key point detection can be performed by using the correlation between the image segmentation and the key point detection. By way of this, not only can the accuracy of the key point detection be improved, but also the mask image and the heatmap can be obtained at one time to achieve end-to-end image processing.

In an embodiment, before Step S102, the image processing method can further specifically include:
predicting at least one sample image of the medical image based on the extraction model to be trained to obtain at least one predicted mask image of the at least one sample image and at least one predicted feature map of the at least one key point;
determining a first loss according to the at least one predicted mask image, and determining a second loss according to the at least one predicted mask image and the at least one predicted feature map based on the attention model to be trained;
training the detection model to be trained according to the first loss and the second loss to obtain a trained detection model.

In an embodiment, the sample image can be a medical image used as a training sample. The predicted mask image can be a mask image of an anatomical structure predicted by the extraction model to be trained. The predicted feature map can be an image corresponding to a feature matrix of the key point predicted by the extraction model to be trained. The first loss can be a loss between the mask image obtained by prediction and a standard mask image. The second loss can be a loss between the heatmap corresponding to the predicted key point and the standard heatmap.

In an embodiment, the terminal can obtain multiple sample images and determine a standard mask image of a concerned anatomical structure in each sample image and a standard heatmap corresponding to the at least one key point. For each sample image, the terminal can input the sample image into the extraction model to be trained, obtain the predicted mask image and the predicted feature map of the key point at the same time, determine the first loss according to the difference between the predicted mask image and the standard mask image, determine the attention coefficient by using the predicted mask image corresponding to the at least one key point based on the attention model to be trained, determine the predicted heatmap corresponding to the at least one key point according to the obtained attention coefficient, and determine the second loss according to the difference between the predicted heatmap and the standard heatmap. The terminal can also obtain a loss corresponding to the current sample image according to the first loss and the second loss, and adjust model parameters of the detection model to be trained according to the losses corresponding to the respective sample images, including adjusting model parameters of the detection model to be trained and model parameters of the attention model to be trained, to obtain the trained detection model.

In an embodiment, during a model training session, multiple sample images can be collected for at least one same region of different patients (for example, the hearts of different patients). Standard mask images are obtained by manually labeling respective concerned anatomical structures (for example, left atrium, right atrium, left ventricle, right ventricle, and the like) in each sample image. Key points can also be manually labeled in each sample image. Standard heatmaps of the key points are generated according to manually labeled key point coordinates. A predicted mask image and a predicted feature map can be obtained at the same time by inputting a sample image into a deep learning network model to be trained. The attention coefficient corresponding to the at least one key point can be determined by using the predicted mask image corresponding to the at least one key point based on one or more attention blocks to be trained. A product of the attention coefficient and the predicted feature map can be used to obtain the predicted heatmap. The first loss can be determined according to the difference between the predicted mask image and the standard mask image. The second loss can be determined according to the difference between the predicted heatmap and the standard heatmap. After the second loss is determined, a weighted summation can be performed on the first loss and the second loss to obtain a loss of the current sample image. During model training, the sample images can be divided into a training set and a validation set. The model training is finally completed for a fixed number of iterations. The weights of the model complying with the best evaluation metrics on the validation set are saved. The evaluation metrics may include, but are not limited to, the Dice distance and the Euclidean distance.

In this embodiment, by predicting the sample image of the medical image based on the extraction model to be trained to obtain the predicted mask image of the sample image and the predicted feature map of the key point, determining the first loss according to the predicted mask image and the standard mask image, obtaining the predicted heatmap of the key point based on the attention model to be trained, determining the second loss according to the predicted heatmap and the standard heatmap, training the detection model to be trained according to the first loss and the second loss, the detection model that meets the performance requirements of image segmentation and key point detection can be obtained, and the accuracy of the image segmentation and key point detection can be improved.

In an embodiment, the step of determining a first loss according to a predicted mask image and a standard mask image of a sample image can specifically include:
determining third losses between predicted mask images and standard mask images of multiple anatomical structures in the sample image; and
performing a weighted summation on the third losses according to preset weights to obtain the first loss.

In an embodiment, the standard mask images can be real segmentation results of all concerned anatomical structures in multiple sample images of a region. The third losses can be losses between the mask images and the real segmentation results of respective anatomical structures predicted by the detection model to be trained.

In an embodiment, the extraction model to be trained can segment one or more anatomical structures in the sample image to obtain predicted mask images corresponding to the respective anatomical structures. The extraction model determines a third loss corresponding to the respective predicted mask images according to the standard mask images of the anatomical structures. The extraction model performs the weighted summation on all obtained third losses according to the preset weights to obtain the first loss.

In an embodiment, taking a standard section of a parasternal pulmonary artery along a long axis of an ultrasonic image as an example, the concerned anatomical structures may include the pulmonary artery trunk (PA), the left pulmonary artery (LPA), the right pulmonary artery (RPA), and the aorta (AO), and the backgrounds are included. The extraction model to be trained can predict five mask images, i.e., predicted mask images. The real segmentation results of the above anatomical structures and the backgrounds are manually determined as standard mask images. Then the first loss Loss_{seg} can be determined by Formula (1).

$$L o s {s}_{s e g} = {\sum }_{i = 1}^{N} {ω}_{i} [ - {( 1 - {p}_{t}^{i} )}^{γ} log ( {p}_{t}^{i} ) + ( 1 - \frac{2 \vert {y}_{p}^{i} ⋂ {y}_{t}^{i} \vert}{\vert {y}_{p}^{i} \vert + \vert {y}_{t}^{i} \vert} ) ] , \qquad ( 1 )$$

$${p}_{t}^{i} = \{ \begin{matrix}{y}_{p}^{i} , {y}_{t}^{i} = 1 \\ 1 - {y}_{p}^{i} , {y}_{t}^{i} = 0\end{matrix} .$$

In Formula (1), N represents the total number of categories of the anatomical structures and the backgrounds. For example,

$$N = 5 \cdot {y}_{p}^{i}$$

represents the predicted mask image of the i-th category by the extraction model to be trained.

$${y}_{t}^{i}$$

represents the standard mask image of the i-th category.

$${( 1 - {p}_{t}^{i} )}^{γ}$$

represents a modulation factor. For an easily classified sample

$$( {p}_{t}^{i}$$

is large, for example, 0.9. Accordingly,

$$( 1 - {p}_{t}^{i} )$$

is small, for example, 0.1), the modulation factor can reduce the loss of weights of the sample. For a difficultly classified sample

$$( {p}_{t}^{i}$$

is small, for example, 0.2. Accordingly,

$$( 1 - {p}_{t}^{i} )$$

is large (for example, 0.8), the modulation factor can retain the loss weight of the sample. γ represents a focus parameter (i.e., an adjustable hyperparameter greater than or equal to 0). γ is used to solve the problem of imbalance between positive samples and negative samples during training. When γ=0, Loss_{seg} degenerates into a standard cross-entropy loss. The larger γ is, the stronger the modulation effect is. The loss of easily classified samples can be reduced further, and the model can focus more on learning difficultly classified samples. A positive sample refers to a sample of a patient with a certain disease. A negative sample refers to a sample of a patient without the disease. The problem of imbalance between positive and negative samples means that the number of samples of patients with the disease is significantly more than that of patients without the disease. ωᵢ represents an adjustable hyperparameter used to control the weight of the loss of the i-th category in the whole loss function, and needs to satisfy

$${\sum }_{i = 1}^{N} {ω}_{i} = 1.0 .$$

For the category of one or more anatomical structures that need to be focused on, ωᵢ can be set to a relatively larger value, and conversely, ωᵢ can be set to a smaller value for the category that does not need to be focused, such as the background. ωᵢ corresponds to a category of an anatomical structure. ωᵢ can be set by the user according to specific classification tasks.

For example, when the key point is a pulmonary valve, for example, segmentation masks of this task include five mask images (corresponding to respective anatomical structures) of PA, LPA, AO, RPA, or the background. When this task focuses on PA, the ωᵢ corresponding to PA can be set to a relatively large value, while AO and the background have less correlation with the key point, so the ωᵢ corresponding to the PA or the background can be set to a relatively small value. For example, the ωᵢ of each of PA, LPA, RPA, AO, and the background can be set to 0.3, 0.3, 0.3, 0.05, and 0.05, respectively.

In this embodiment, by determining the third losses between the predicted mask images and the standard mask images of the sample image, and performing the weighted summation on the third losses according to the preset weights to obtain the first loss, the detection model can be trained according to the image segmentation results, and the accuracy of the detection model in the image segmentation can be improved.

In an embodiment, the step of determining the second loss according to the predicted mask image and the predicted feature map based on the attention model to be trained can specifically include:
determining the at least one attention coefficient corresponding to the at least one key point according to the at least one predicted mask image corresponding to the at least one key point;
determining the at least one predicted heatmap corresponding to the at least one key point according to the attention coefficient and the at least one predicted feature map; and
determining the second loss according to the difference between the at least one predicted heatmap and the at least one standard heatmap of the at least one key point.

In an embodiment, the attention coefficient can be a parameter related to attention in the attention mechanism. The at least one predicted heatmap can be at least one heatmap corresponding to the at least one key point predicted by the detection model to be trained. The at least one standard heatmap can be at least one heatmap corresponding to at least one real key point in the at least one sample image.

In an embodiment, the terminal can select the at least one predicted mask image corresponding to the at least one key point, determine the attention coefficient corresponding to the at least one key point according to the at least one predicted mask image, a product of the at least one attention coefficient and the at least one predicted feature map can be determined to obtain the at least one predicted heatmap corresponding to the at least one key point, and obtain the second loss according to the difference between the at least one predicted heatmap and the at least one standard heatmap.

For example, for the key points including a right portal vein (RPV), a main portal vein (MPV), and a branch pulmonary artery (BPA). The PRV and the MPV are located on the PA, and the PRV and MPV have a strong positional relationship with the PA. The attention coefficients of the PRV and the MPV can be respectively determined according to the predicted mask image of the PA. While the key point BPA is located at an intersection of the PA, LPA, and RPA, and has a positional relationship with the PA, LPA, and RPA, the attention coefficient of BPA can be determined according to the predicted mask images of the PA, LPA, and RPA. Then, the products of the attention coefficients of the RPV, MPV, and BPA can be determined with their respective predicted feature maps to obtain the predicted heatmaps of the key points. The second loss is determined according to the difference between the predicted heatmaps and the standard heatmaps. The second loss Lossₚₜ can be determined by Formula (2).

$${Loss}_{p t} = {\sum }_{i = 1}^{M} {( {x}_{t}^{i} - {x}_{p}^{i} )}^{2} . \qquad ( 2 )$$

In Formula (2), M represents the total number of categories of key points, for example, M=3.

$${x}_{p}^{i}$$

represents the predicted heatmap of the i-th category of the key points.

$${x}_{t}^{i}$$

represents the standard heatmap of the i-th category of the key points.

In this embodiment, by determining the attention coefficients corresponding to the key points according to the predicted mask images corresponding to the key points, determining the predicted heatmap corresponding to the points according to the attention coefficients and the predicted feature maps, and determining the second loss according to the difference between the predicted heatmaps and the standard heatmaps of the key points, the detection model can be trained according to the key point detection results, and the accuracy of the detection model in key point detection can be improved.

In an embodiment, the step of training the detection model to be trained according to the first loss and the second loss to obtain the trained detection model can specifically include:
performing the weighted summation on the first loss and the second loss to obtain a fourth loss of the detection model to be trained; and
adjusting model parameters of the detection model to be trained according to the fourth loss to obtain the trained detection model.

In an embodiment, the fourth loss can be the total loss of the image segmentation and the key point detection.

In an embodiment, the terminal can perform a weighted summation on the first loss and the second loss according to preset weights to obtain the fourth loss, and adjust model parameters of the detection model according to the fourth loss. Adjusting model parameters of the detection model includes adjusting the parameters of the extraction model and the parameters of the attention model.

In an embodiment, the fourth loss Loss can be determined by Formula (3).

$$Loss = α {Loss}_{s e g} + ( 1 - α ) {Loss}_{p t} . \qquad ( 3 )$$

In Formula (3), a is an adjustable hyperparameter used to adjust the relative weights α and (1−α) of the first loss Loss_{seg} and the second loss Lossₚₜ, respectively.

In this embodiment, by performing the weighted summation on the first loss and the second loss to obtain the fourth loss of the detection model to be trained, and adjusting the model parameters of the detection model to be trained according to the fourth loss to obtain the trained detection model, the losses of the image segmentation and the key point detection can be comprehensively considered, so that the trained detection model can meet the performance requirements of both the image segmentation and the key point detection at the same time.

In an embodiment, the step of inputting the medical image into the trained extraction model to obtain the at least one mask image of the at least one target region in the medical image and the at least one feature map of the at least one key point can specifically include:
performing shallow feature extraction on the medical image to obtain a shallow feature matrix of the medical image;
performing encoding and decoding on a shallow feature matrix to obtain an information feature matrix including mask information of the mask image (including 0-1 binary information in the mask) and position information of the key point; and
performing dimensionality reduction on the information feature matrix to obtain the at least one mask image and the at least one feature map of the at least one key point.

In an embodiment, the shallow feature extraction can be a feature extraction of the input medical image by the first layer convolution module. The shallow feature matrix can be an image feature matrix extracted by the first layer convolution module.

In an embodiment, the trained extraction model can first perform rough feature extraction on the input medical image to reduce the size of the medical image and obtain the shallow feature matrix of the medical image. Then, the trained extraction model can perform encoding and decoding on the shallow feature matrix to obtain a feature matrix with regional information (mask information of the mask image) and position information (position information of the key point), and perform dimensionality reduction on the feature matrix to obtain the at least one mask image and the at least one feature map of the at least one key point.

In this embodiment, by performing the shallow feature extraction on the medical image to obtain the shallow feature matrix of the medical image, performing encoding and decoding on the shallow feature matrix to obtain the information feature matrix containing the mask information of the mask image and the position information of the key point, and performing the dimensionality reduction on the information feature matrix to obtain the at least one mask image and the at least one feature map of the at least one key point, the image segmentation result and the key point detection result of the medical image can be obtained at the same time through one detection model, and the complexity of medical image processing can be reduced.

To facilitate those skilled in the art to deeply understand the embodiments of the present disclosure, a specific example is described below.

The present disclosure provides an end-to-end detection method for the multi-task of ultrasonic image segmentation and key point detection. End-to-end implementation of the two tasks of image segmentation and key point detection can be achieved merely through a simple network structure, which reduces the training cost for the detection model and improves the inference speed of the detection model. In addition, the attention mechanism is established between segmentation targets and corresponding key points to enhance the connection between the segmentation regions and the key points, and improve the accuracy of the detection model for the key points. Moreover, a suitable loss function is designed for this special structure to improve the accuracy of the detection model.

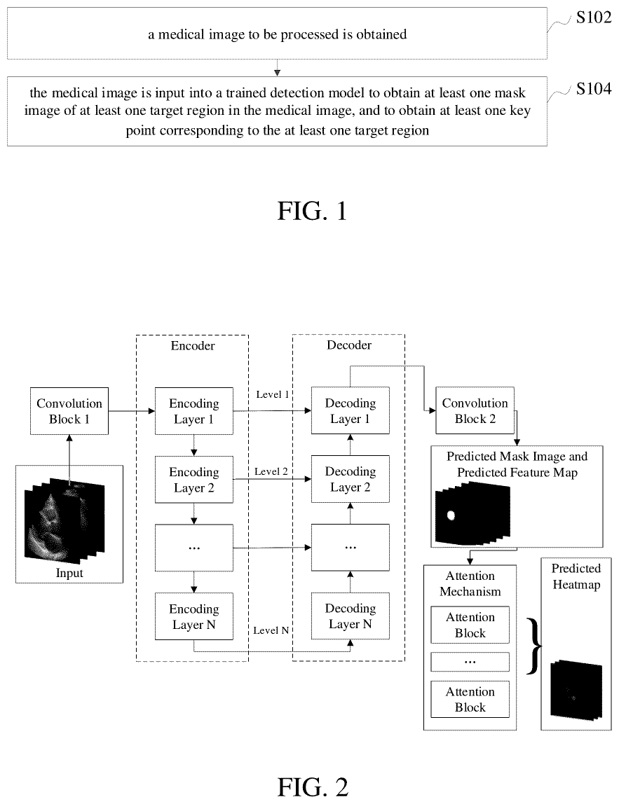

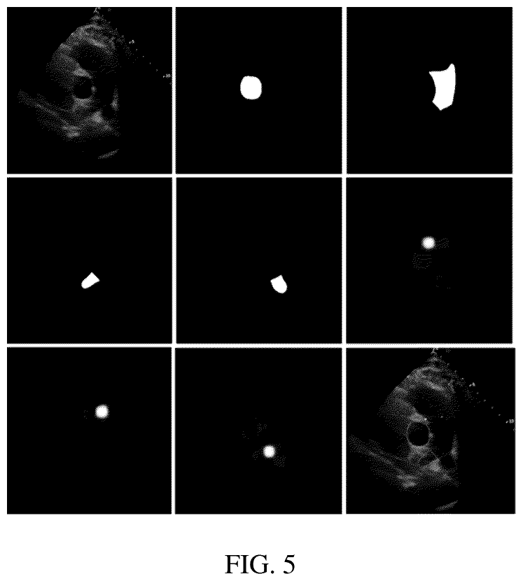

In an embodiment, a model structure used in the above image processing method is shown in FIG. 2. The model uses a classic encoder-decoder structure, which presents a simple U-shape, and multiple attention blocks applied with an attention mechanism are added at the tail of the model. Referring to FIG. 2, first, the shallow feature extraction is performed on input ultrasonic images through a convolution block 1 (the first convolution block) to reduce the size of the ultrasonic images to be detected. Then, feature encoding and feature decoding are completed through the encoder and the decoder, and skip connections are used between encoding layers and decoding layers of the same level (such as level 1, level 2, . . . , or level N shown in FIG. 5) to obtain the information feature matrix with the regional information and the position information. For the encoder and the decoder, appropriate structures can be selected according to the difficulty of actual tasks. Further, a convolution block 2 (the second convolution block) is configured to perform the dimensionality reduction on the information feature matrix to obtain the predicted mask image and the predicted feature map of each key point. Since each key point to be detected can be located on a different mask image, there is a strong correlation between the key point and the predicted mask image. Therefore, based on the prior position information of the key points and the mask images, the attention blocks can be configured to determine the attention coefficients between the predicted feature map of the respective key points and the corresponding predicted mask images. Finally, products of the obtained attention coefficients and the predicted feature maps of the key points can be determined to obtain the predicted heatmap of each key point. As shown in FIG. 2, the encoding layer of the same level is connected to the decoding layer of the same level. The encoding layers of multiple levels are connected in series in ascending order of levels (e.g., an encoding layer 1 is connected to an encoding layer 2, . . . , an encoding layer N−1 is connected to an encoding layer N). The decoding layers of multiple levels are connected in series in descending order of levels (e.g., a decoding layer N is connected to a decoding layer N−1, . . . , a decoding layer 2 is connected to a decoding layer 1).

In an embodiment, to improve the accuracy of model prediction, during the training, different loss functions are used to determine the mask images and heatmaps, respectively, and backpropagation is performed based on the weighted summation of the results of different loss functions to adjust model gradients. For the loss calculation of mask images, a Focal loss function with weights and a Dice loss function with weights can be used. When performing quantitative analysis on a certain structure in a medical ultrasonic image, it is often necessary to obtain an accurate segmentation of the structure, but the correlation between the surrounding structures and the certain structure cannot be ignored. Therefore, appropriate weights can be set through prior information, which can not only achieve the focusing on the certain structure, but also obtain plenty of information about the surrounding structures. The loss function of the mask image is as shown in Formula (4).

$${Loss}_{s e g} = {\sum }_{i = 1}^{N} {ω}_{i} [ - {( 1 - {p}_{t}^{i} )}^{γ} log ( {p}_{t}^{i} ) + ( 1 - \frac{2 \vert {y}_{p}^{i} ⋂ {y}_{t}^{i} \vert}{\vert {y}_{p}^{i} \vert + \vert {y}_{t}^{i} \vert} ) ] , \qquad ( 4 )$$

$${p}_{t}^{i} = \{ \begin{matrix}{y}_{p}^{i} , {y}_{t}^{i} = 1 \\ 1 - {y}_{p}^{i} , {y}_{t}^{i} = 0\end{matrix} .$$

In Formula (4), N represents the total number of mask categories in the image segmentation. For example, the total number of categories of the anatomical structures and the backgrounds.

$${y}_{p}^{i}$$

represents the predicted mask image of the i-th category by the detection model.

$${y}_{t}^{i}$$

represents the real mask image of the i-th category. γ represents an adjustable hyperparameter. ωᵢ represents an adjustable hyperparameter used to control the weight of the loss of the i-th category in the whole mask loss function, and needs to satisfy

$${\sum }_{i = 1}^{N} {ω}_{i} = 1 \text{.0} .$$

For a category or multiple categories that need to be concerned, the ωᵢ can be set to a relatively large value, and conversely, for a category or multiple categories, such as the backgrounds that do not need to be concerned, the ωᵢ can be set to a smaller value.

In an embodiment, for the loss calculation of the heatmap, a classic mean squared error (MSE) loss function is selected, which is determined by Formula (5).

$${Loss}_{p t} = {\sum }_{i = 1}^{M} {( {x}_{t}^{i} - {x}_{p}^{i} )}^{2} . \qquad ( 5 )$$

In Formula (5), M is the total number of categories of the key points.

$${x}_{p}^{i}$$

represents the predicted heatmap of the i-th category of key points.

$${x}_{t}^{i}$$

represents the real heatmap of the i-th category of key points.

The entire loss function can be determined by Formula (6).

$$Loss = α {Loss}_{s e g} + ( 1 - α ) {Loss}_{p t} . \qquad ( 6 )$$

In Formula (6), a represents an adjustable hyperparameter used to adjust the weights of the loss functions of the mask image and the heatmap.

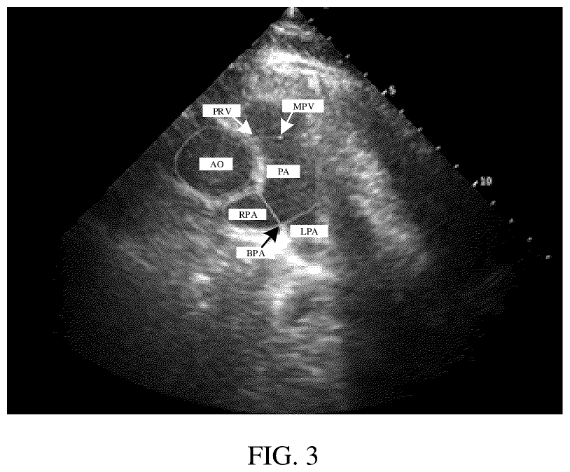

In an embodiment, taking a standard section of a parasternal pulmonary artery of an ultrasonic image at a long axis shown in FIG. 3 as an example, it is necessary to obtain four anatomical structures including the AO, PA, LPA, and RPA, and three key points including the RPV, MPV, and BPA.

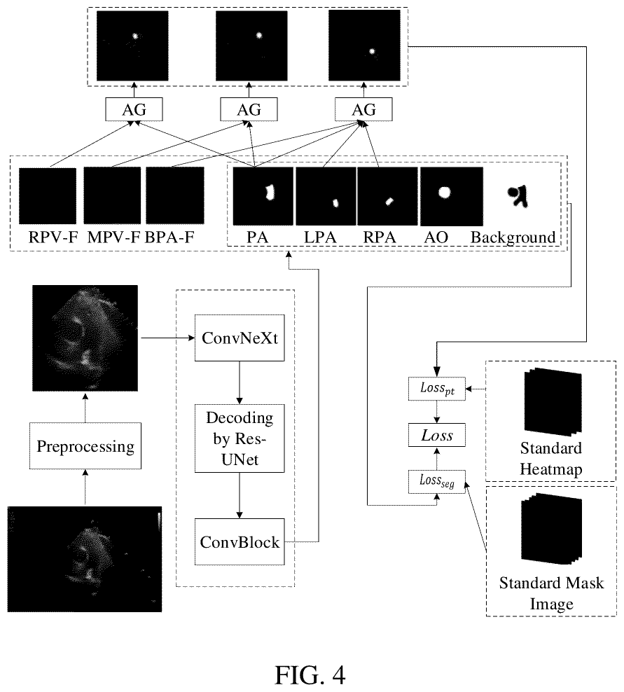

In an embodiment, the network structure for a section of a parasternal pulmonary artery along a long axis is shown in FIG. 4. Referring to FIG. 4, first, the standard section of the parasternal pulmonary artery along the long axis is preprocessed and unified to a size of 448×448 before being sent to the network. In the whole network structure, the encoder uses a ConvNeXt (a convolutional neural network) to complete feature extraction and encoding in the section of the pulmonary artery along the long axis. The decoder uses a Res-UNet (combining a residual network and a U-shaped network) to complete the decoding of the extracted features. Then, through a ConvBlock composed of two groups of 3×3 convolution layers, batch normalization layers, and Relu activation function layers, the predicted results of the five anatomical structures including the backgrounds (PA, LPA, RPA, AO, and backgrounds) and the feature matrices of three key points (RPV-F, MPV-F, BPA-F), are obtained. For the five anatomical structures, each ωᵢ in Loss_{seg} can be set to 0.3, 0.3, 0.3, 0.05, and 0.05, to achieve the focusing on the three anatomical structures of PA, LPA, and RPA. For the feature matrices (feature maps) of the three key points, it is necessary to use the Attention Gate (AG) mechanism in Attention UNet (combining a U-shaped network and an attention mechanism) to determine the attention coefficients in turn. The RPV and MPV are located on the PA and have a strong positional relationship with PA, so the attention coefficients of the RPV and MPV can be determined based on the predicted mask image of PA, respectively. While the BPA is located at an intersection of the PA, LPA, and RPA, the attention coefficient of the BPA can be determined based on the predicted mask images of the three anatomical structures of the PA, LPA, and RPA at the same time, and finally, the predicted heatmaps of the three key points and the Lossₚₜ are obtained.

In an embodiment, FIG. 5 shows a model prediction result of a section of a parasternal pulmonary artery along a long axis. In FIG. 5, from left to right and top to bottom, an input image, a result of aorta, a result of pulmonary artery trunk, a result of right pulmonary artery branch, a result of left pulmonary artery branch, a predicted heatmap of a right root point of a pulmonary valve, a predicted heatmap of a midpoint of a pulmonary valve, a predicted heatmap of a pulmonary artery bifurcation, and a final visualization result are given in sequence. The detection model trained using this network structure can not only obtain important anatomical structures and key points in the ultrasonic image in an end-to-end manner, but also significantly reduce the complexity and parameter amount of the detection model, reducing the cost of training and inference, thereby improving the accuracy of the detection model.

The above end-to-end detection method for the multi-task of ultrasonic image segmentation and key point detection uses a classic customizable encoder-decoder structure for the main part of the detection model. For each level of the encoder and decoder, structure blocks with different structures, different depths, and different parameter amounts can be used according to the difficulty of tasks and the scale of data sets, and the overall structure is simple and flexible. For the two tasks of image segmentation and key point detection, multiple detection heads do not need to be added, and the ultrasonic image segmentation prediction result and key point detection result can be obtained at the same time. In addition, combined with the prior position information, an attention mechanism is constructed between the anatomical structures of the ultrasonic image and the corresponding key points to enhance the connection between the anatomical structures and the key points, and improve the accuracy of the detection model for key points. Moreover, to reduce the impact of irrelevant regions in the ultrasonic image on key anatomical structures during training, a flexible loss function is designed, which can reduce the weights of regions similar to the background in the ultrasonic image to improve the segmentation accuracy of key anatomical structures.

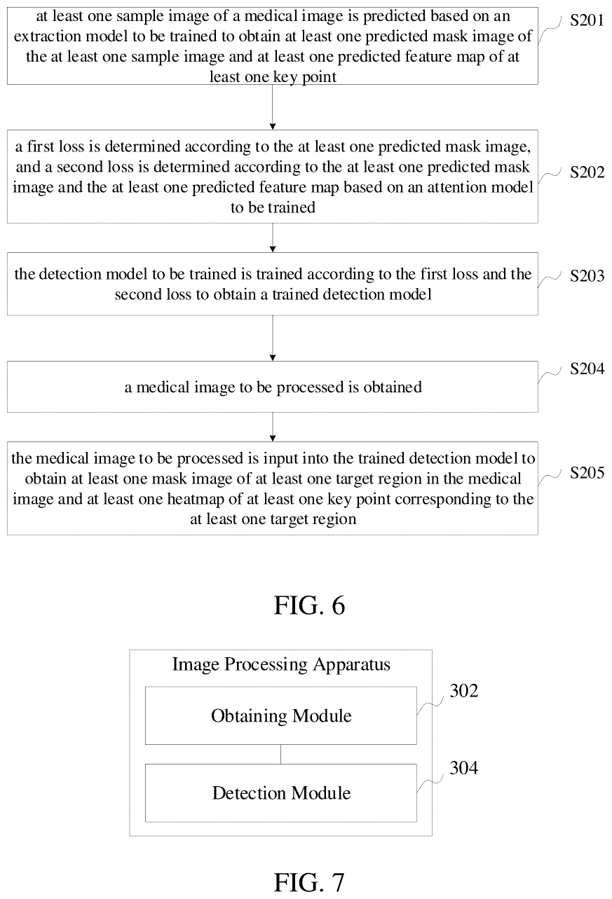

In an embodiment, as shown in FIG. 6, an image processing method is provided, which includes the following Step S201 to Step S205.

In Step S201, at least one sample image of at least one medical image is predicted based on an extraction model to be trained to obtain at least one predicted mask image of the sample image and at least one predicted feature map of at least one key point.

In Step S202, a first loss is determined according to the at least one predicted mask image, and a second loss is determined according to the at least one predicted mask image and the at least one predicted feature map based on an attention model to be trained.

In Step S203, the detection model to be trained is trained according to the first loss and the second loss to obtain a trained detection model.

In Step S204, a medical image to be processed is obtained.

In Step S205, the medical image to be processed is input into the trained detection model to obtain at least one mask image of at least one target region in the medical image and at least one heatmap of the at least one key point corresponding to the at least one target region.

In an embodiment, the terminal can input the at least one sample image into the extraction model to be trained to obtain the at least one predicted mask image of the sample image and the predicted feature map of the key point, determine the first loss according to the difference between the predicted mask image and the standard mask image, determine the at least one attention coefficient corresponding to the at least one key point according to the at least one predicted mask image corresponding to the at least one key point based on the attention model to be trained, determine the predicted heatmap according to the attention coefficient and the predicted feature map of the key point, determine the second loss according to the difference between the predicted heatmap and the standard heatmap, adjust parameters of the detection model to be trained according to the first loss and the second loss, including adjusting the parameters of the extraction model and the parameters of the attention model, to obtain a trained detection model. For a medical image to be subjected to the image segmentation and the key point detection, the terminal can directly input the medical image into the trained detection model to obtain the at least one mask image of the at least one target region and the at least one heatmap of the at least one key point at the same time. The mask image can reflect the image segmentation result of the at least one target region in the medical image, and the heatmap can reflect the key point detection result of the medical image.

The above image processing method can obtain both the mask image reflecting the image segmentation result and the heatmap reflecting the key point detection result at the same time based on one detection model, without the requirement to perform model training separately for the image segmentation and the key point detection, and can be well compatible with the two tasks of the image segmentation and the key point detection.

Although the various steps in the flowcharts involved in the above embodiments are shown in sequence according to the arrows in the drawings, these steps are not necessarily executed in sequence according to the arrow directions. Unless explicitly stated herein, the execution of these steps is not strictly limited in order, and these steps can be executed in other orders. In addition, at least some of the steps in the flowcharts involved in the above embodiments can include multiple steps or multiple stages. These steps or stages are not necessarily executed simultaneously, but can be executed at different times. The execution order of these steps or stages is not necessarily sequential, but can be performed in turn or alternately with at least a part of other steps or stages of other steps.

Based on the same inventive concept, an image processing apparatus is also provided in an embodiment of the present disclosure for implementing the above image processing method. An implementation of the image processing apparatus to address the problem is similar to the implementation of the image processing method recited hereinbefore. Therefore, the specific definition of the image processing apparatus provided in one or more embodiments below can refer to the definition of the image processing method above, which is repeated here.

In an embodiment, as shown in FIG. 7, an image processing apparatus is provided. The image processing apparatus includes an obtaining module 302 and a detection module 304.

The obtaining module 302 is configured to obtain a medical image to be processed.

The detection module 304 is configured to input the medical image into a trained detection model to obtain at least one mask image of at least one target region in the medical image and at least one heatmap of at least one key point corresponding to the at least one target region.

In an embodiment, the detection module 304 is further configured to input the medical image into a trained extraction model to obtain the at least one mask image of the at least one target region in the medical image and the at least one feature map of the at least one key point. The detection module 304 is further configured to apply an attention mechanism to the at least one feature map according to the at least one mask image based on a trained attention model to obtain the at least one heatmap of the at least one key point.

In an embodiment, the image processing apparatus further includes a training module configured to predict a sample image of the medical image based on an extraction model to be trained to obtain a predicted mask image of the sample image and a predicted feature map of the key point, determine a first loss according to the predicted mask image, and determine a second loss according to the predicted mask image and the predicted feature map based on an attention model to be trained, and train the detection model to be trained according to the first loss and the second loss to obtain the trained detection model.

In an embodiment, the training module is further configured to determine a third loss between the predicted mask image and the standard mask image of the sample image, and perform a weighted summation on the third loss according to preset weights to obtain the first loss.

In an embodiment, the training module is further configured to determine at least one attention coefficient corresponding to the at least one key point according to the at least one predicted mask image corresponding to the at least one key point, determine the at least one predicted heatmap corresponding to the at least one key point according to the at least one attention coefficient, and determine the second loss according to the difference between the at least one predicted heatmap and the at least one standard heatmap of the at least one key point.

In an embodiment, the training module is further configured to perform a weighted summation on the first loss and the second loss to obtain a fourth loss of the detection model to be trained, and adjust model parameters of the detection model to be trained according to the fourth loss to obtain the trained detection model.

In an embodiment, the detection module 304 is further configured to perform shallow feature extraction on the medical image to obtain a shallow feature matrix of the medical image, perform encoding and decoding on the shallow feature matrix to obtain an information feature matrix containing mask information of the mask image and position information of the key point, and perform dimensionality reduction on the feature matrix to obtain the at least one mask image and the at least one feature map of the at least one key point.

Each module in the above image processing apparatus can be implemented in whole or in part by software, hardware, or a combination thereof. The above modules can be embedded in or independent of a processor in a computer device in hardware, or stored in a memory in the computer device in software, so that the processor can invoke and execute the operations corresponding to the above modules.

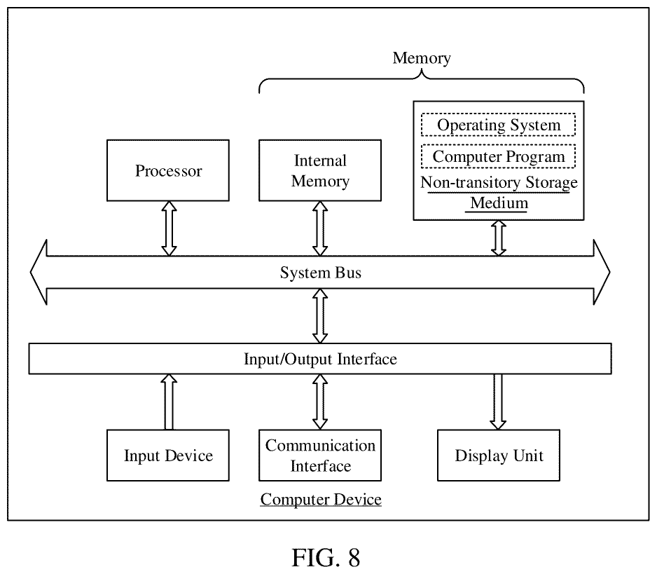

In an embodiment, a computer device is provided, which can be a terminal. An internal structural diagram of the computer device can be as shown in FIG. 8. The computer device includes a processor, a memory, an input/output interface, a communication interface, a display unit, and an input device. The processor, the memory, and the input/output interface are connected through a system bus. The communication interface, the display unit, and the input device are connected to the system bus through the input/output interface. The processor of the computer device is configured to provide computing and control capabilities. The memory of the computer device includes a non-transitory storage medium and an internal memory. The non-transitory storage medium stores an operating system and a computer program. The internal memory provides an environment for the operation of the operating system and the computer program in the non-transitory storage medium. The input/output interface of the computer device is configured to exchange information between the processor and an external device. The communication interface of the computer device is configured to communicate with an external terminal in a wired or wireless manner. The wireless manner can be implemented through WIFI, mobile cellular network, near field communication (NFC), or other techniques. The computer program, when executed by the processor, implements the image processing method. The display unit of the computer device is configured to form a visible picture, and may be a display screen, a projection device, or a virtual reality imaging device. The display screen may be a liquid crystal display screen or an electronic ink display screen. The input device of the computer device may be a touch layer covered on the display screen, a button, a trackball, a touchpad arranged on a housing of the computer device, an external keyboard, a touchpad, or a mouse.

The structure shown in FIG. 8 is only a partial structure related to the solution of the present disclosure, and does not constitute a limitation on the computer device to which the solution of the present disclosure is applied. A specific computer device may include more or fewer components than those shown in the drawings, combine some components, or have different component arrangements.

In an embodiment, a computer device is further provided, including a memory and a processor. The memory stores a computer program. The processor, when executing the computer program, implements the image processing method provided in the above embodiments.

In an embodiment, a non-transitory computer-readable storage medium is provided, and a computer program is stored thereon. The computer program, when executed by a processor, implements the image processing method provided in the above embodiments.

In an embodiment, a computer program product is provided. The computer program product includes a computer program. The computer program, when executed by a processor, implements the image processing method provided in the above embodiments.

User information (including but not limited to user device information, user personal information, and the like) and data (including but not limited to data used for analysis, storage, display, and the like) involved in the present disclosure are all information and data authorized by users or fully authorized by all parties. The collection, use, and processing of related data complies with relevant laws, regulations, and standards.

All or part of the processes in the image processing method provided in the above embodiments can be completed by instructing relevant hardware through a computer program. The computer program can be stored in a non-transitory computer-readable storage medium. When executed, the computer program implements the image processing method provided in the above embodiments. Any reference to the memory, a database, or other media used in the various embodiments provided in the present disclosure may include at least one of non-transitory memory and volatile memory. The non-transitory memory may include a read-only memory (ROM), a magnetic tape, a floppy disk, a flash memory, an optical memory, a high-density embedded non-transitory memory, a resistive random access memory (ReRAM), a magnetoresistive random access memory (MRAM), a ferroelectric random access memory (FRAM), a phase change memory (PCM), a graphene memory, or the like. A transitory memory may include a random access memory (RAM), an external cache memory, or the like. For explanation but not limitation, the RAM can be in various forms, such as static random access memory (SRAM) or dynamic random access memory (DRAM). The database involved in the various embodiments provided in the present disclosure may include at least one of a relational database and a non-relational database. The non-relational database may include a blockchain-based distributed database, and the like, but is not limited thereto. The processor involved in the various embodiments provided in the present disclosure may be a general-purpose processor, a central processing unit, a graphics processor, a digital signal processor, a programmable logic device, a quantum computing-based data processing logic device, an artificial intelligence (AI) processor, or the like, but is not limited thereto.

The technical features of the above embodiments can be combined arbitrarily. To make the description concise, not all possible combinations of the technical features in the above embodiments are described. However, as long as there is no contradiction in a combination of these technical features, all of the technical features should be considered as falling within the scope of the present disclosure.

The above embodiments only involve some implementations of the present disclosure, and the descriptions thereof are detailed, but should not be construed as limiting the scope of the present disclosure. It should be noted that those of ordinary skill in the art can also make some modifications or improvements without departing from the concept of the present disclosure. These modifications or improvements all fall within the scope of protection of the present disclosure.

What is claimed is:

1. An image processing method, comprising:
obtaining a medical image to be processed; and
inputting the medical image into a trained detection model to obtain at least one mask image of at least one target region in the medical image, and to obtain at least one key point corresponding to the at least one target region.

2. The image processing method according to claim 1, wherein inputting the medical image into the trained detection model to obtain the at least one mask image of the at least one target region in the medical image, and to obtain the at least one key point corresponding to the at least one target region comprises:
inputting the medical image into the trained detection model to obtain the at least one mask image of the at least one target region in the medical image and at least one feature map of the at least one key point; and
obtaining at least one heatmap of the at least one key point according to the at least one mask image and the at least one feature map based on the trained detection model.

3. The image processing method according to claim 2, wherein the trained detection model is obtained by:
for each sample image of a plurality of sample images,
predicting the sample image based on a detection model to be trained to obtain at least one predicted mask image of at least one sample region of the sample image and at least one predicted feature map of at least one sample key point corresponding to the at least one sample region; and
determining a first loss according to the at least one predicted mask image, and determining a second loss according to the at least one predicted mask image and the at least one predicted feature map corresponding to the at least one sample region based on the detection model to be trained; and
training the detection model to be trained according to the first loss and the second loss to obtain the trained detection model for the plurality of sample images.

4. The image processing method according to claim 3, wherein determining the first loss according to the at least one predicted mask image comprises:
determining third losses between predicted mask images and standard mask images of the plurality of sample images; and
performing a weighted summation on the third losses according to preset weights to obtain the first loss;
wherein the third loss represents a difference between the predicted mask image and the standard mask image of the sample image.

5. The image processing method according to claim 3, wherein determining the second loss according to the at least one predicted mask image and the at least one predicted feature map based on the detection model to be trained comprises:
determining at least one attention coefficient corresponding to the at least one key point according to the at least one predicted mask image corresponding to the at least one key point;
determining at least one predicted heatmap corresponding to the at least one key point according to the at least one attention coefficient and the at least one predicted feature map; and
determining the second loss according to a difference between the at least one predicted heatmap and at least one standard heatmap of the at least one key point.

6. The method according to claim 3, wherein training the detection model to be trained according to the first loss and the second loss to obtain the trained detection model comprises:
performing a weighted summation on the first loss and the second loss to obtain a fourth loss of the detection model to be trained; and
adjusting model parameters of the detection model to be trained according to the fourth loss to obtain the trained detection model.

7. The image processing method according to claim 2, wherein inputting the medical image into the trained detection model to obtain the at least one mask image of the at least one target region in the medical image and the at least one feature map of the at least one key point comprises:
performing shallow feature extraction on the medical image to obtain a shallow feature matrix of the medical image;
performing encoding and decoding on the shallow feature matrix to obtain an information feature matrix containing mask information of the at least one mask image and position information of the at least one key point; and
performing dimensionality reduction on the information feature matrix to obtain the at least one mask image and the at least one feature map of the at least one key point.

8. The image processing method according to claim 2, wherein obtaining the at least one heatmap of the at least one key point according to the at least one mask image and the at least one feature map based on the trained detection model comprises:
determining at least one attention coefficient corresponding to the at least one key point according to the at least one mask image corresponding to the at least one key point; and
obtaining the at least one heatmap of the at least one key point based on a product of the at least one attention coefficient and the at least one feature map of the at least one key point.

9. The image processing method according to claim 2, wherein the trained detection model comprises an encoder-decoder structure, and the encoder-decoder structure comprises skip connections configured to connect encoding layers and decoding layers of the same level, respectively.

10. The image processing method according to claim 1, wherein the medical image comprises an ultrasonic image.

11. The image processing method according to claim 5, wherein the second loss is determined based on a mean squared error loss.

12. The image processing method according to claim 1, wherein the at least one target region comprises at least one of a pulmonary artery trunk, a left pulmonary artery branch, a right pulmonary artery branch, or an aorta; or
the at least one key point comprises at least one of a right root point of a pulmonary valve, a midpoint of a pulmonary valve, or a pulmonary artery bifurcation.

13. The image processing method according to claim 5, wherein for at least one sample key point located on a single sample anatomical structure of the sample region, the at least one attention coefficient is determined based on at least one predicted mask image of the anatomical structure; and
for at least one key point located at a junction of a plurality of anatomical structures, at least one attention coefficient is determined jointly based on mask images of the plurality of anatomical structures.

14. The image processing method according to claim 3, wherein a weight of the first loss and a weight of the second loss during training is controlled by an adjustable hyperparameter.

15. The image processing method according to claim 3, wherein the first loss is determined based on a Focal loss function and a Dice loss function.

16. The image processing method according to claim 4, wherein the preset weights include weights of a plurality of sample anatomical structures, and a sum of the weights of the plurality of sample anatomical structures is 1.

17. A model training method, comprising:
predicting at least one sample image based on a detection model to be trained to obtain at least one predicted mask image of the sample image and at least one predicted feature map of at least one key point;
determining a first loss according to the at least one predicted mask image, and determining a second loss according to the at least one predicted mask image and the at least one predicted feature map based on the detection model to be trained; and
training the detection model to be trained according to the first loss and the second loss to obtain the trained detection model.

18. A non-transitory computer-readable storage medium, storing at least one computer program thereon, wherein the at least one computer program, when executed by at least one processor, performs the image processing method according to claim 1.

19. An image processing system, comprising:
encoding layers of multiple levels, configured to perform feature encoding on a medical image;
decoding layers of multiple levels, configured to perform feature decoding on the medical image; and
an attention block, configured to obtain at least one mask image of at least one target region in the medical image, and to obtain at least one key point corresponding to the at least one target region.

20. The image processing system according to claim 19, further comprising:
a first convolution block, configured to obtain a medical image to be processed; and
a second convolution block, configured to input the medical image into a trained detection model to obtain at least one mask image of at least one target region in the medical image, and to obtain at least one key point corresponding to the at least one target region.
